(19) United States
(12) Patent Application Publication
(10) Pub. No.: US 2012/0235629 A1
(43) Pub. Date: Sep. 20, 2012

(54) Bike Jumper Kits

(76) Inventor: Douglas K. Wood, West Chester, PA (US)

(21) Appl. No.: 13/356,347

(22) Filed: Jan. 23, 2012

Related U.S. Application Data
(60) Provisional application No. 61/461,667, filed on Jan. 21, 2011.

(51) Int. Cl. H02J 7/00

(52) U.S. Cl. 320/107

(57) ABSTRACT

The invention provides a kit comprising a system of jumper cables designed specifically for use with motorcycles, ATVs, boats, and similar vehicles and comprises a versatile system of jumper cables and connectors for use in charging and jump starting motorcycles, ATVs, boats, and similar vehicles.

### CLAIM OF PRIORITY

This patent application claims priority under 35 USC 119 (e) (1) from U.S. Provisional Patent Application Ser. No. 61/461,667 filed Jan. 21, 2011, of common inventorship herewith entitled, “Bike Jumper Kits.”

### FIELD OF THE INVENTION

The present invention pertains to the field of jumper cables. and more specifically to the field of jumper cables for motorcycles and other smaller battery machines.

### BACKGROUND OF THE INVENTION

The prior art has put forth several designs for jumper cables for motorcycles. Among these are:

US Patent Application publication 2004/0145340 to Randy Jay Horenstein describes a motorcycle jumper cable and battery charger describes a motorcycle jumper cable having a permanently installed section on a motorcycle and a detachable section for connecting an undercharged motorcycle battery with an auxiliary battery to jump start or boost the undercharged battery.

U.S. Pat. No. 6,527,585 to Robert Pannone describes a jumper cable system for charging batteries on vehicles such as motorcycles, lawnmowers, lawn tractors and small boats comprising a first cable having a pair of battery clips at one end and a male plug at a second end and a second cable having a pair of battery clips at one end and a female socket at a second end. The male plug is sized to fit within an electrical outlet such as an automobile cigarette lighter socket. The female socket is sized to mate with the male plug and form an electrical connection therebetween.

U.S. Pat. No. 4,829,223 to Daniel M. Broberg and Terry A. Prentice describes a vehicle battery charger comprising a vehicle battery harness including a battery charger having a cable permanently attached to the electrical or battery system of a storage battery equipped vehicle, the cable having a terminal which can only be connected in a correct polarity with the battery charger for a safe connection to charge the batter of the vehicle.

None of these prior art references describe the present invention.

### SUMMARY OF THE INVENTION

It is an object of the present invention to provide an improved battery charger system for motorcycles and other smaller battery equipped machines.

### BRIEF DESCRIPTION OF THE DRAWINGS

FIG. 1 is a perspective view of the cable of the present invention designed for battery to bike connection.

FIG. 2 is a perspective view of the cable of the present invention designed for jumper cable to bike connection

FIG. 3 is a perspective view of the cable of the present invention designed for bike to bike connection.

FIG. 4 is a perspective view of the cable of the present invention showing a close up of the cable designed for battery to bike connection.

FIG. 5 is a side view of the cable of the present invention designed for battery to bike connection.

FIG. 6 is a side view of the cable of the present invention designed for jumper cable to bike connection

FIG. 7 is a side view of the cable of the present invention designed for bike to bike connection.

FIG. 8 is a side view of the cable of the present invention showing the cable designed for battery to bike connection.

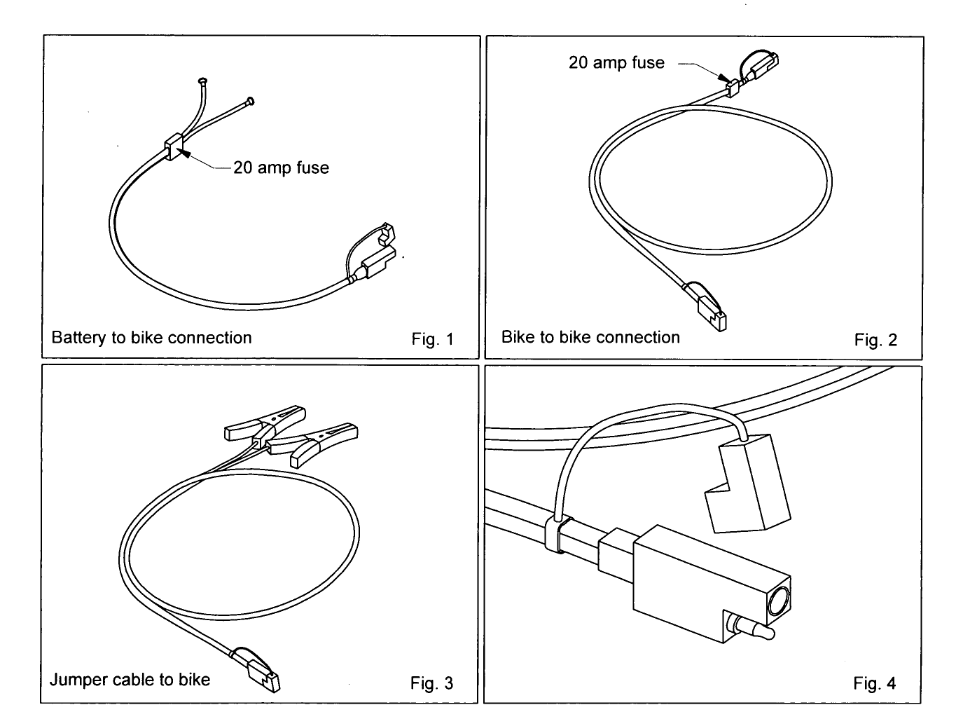

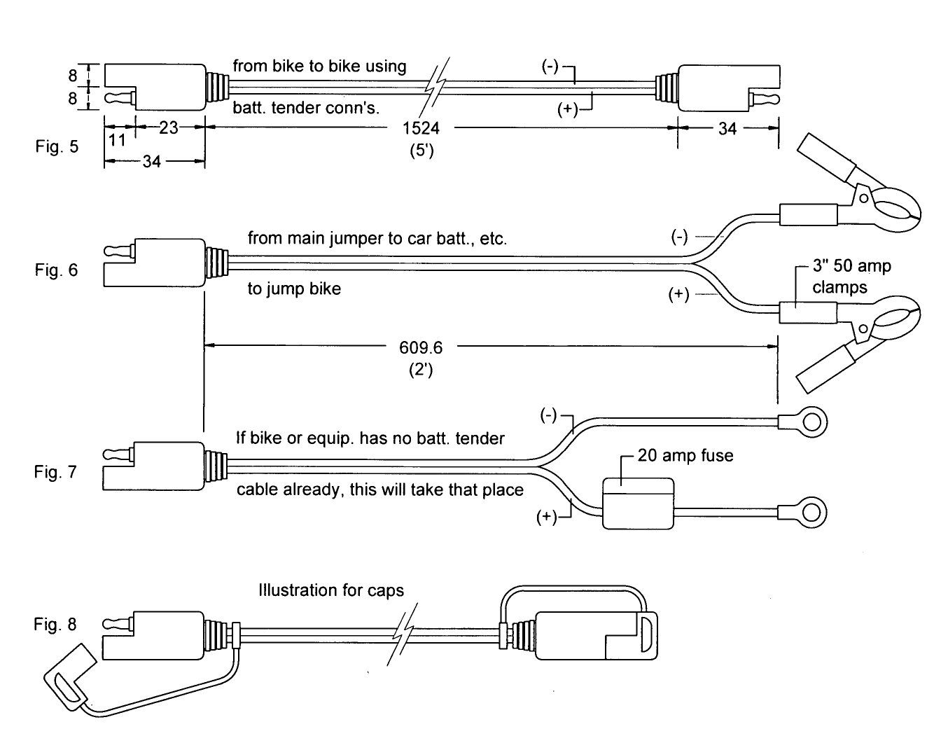

### DETAILED DESCRIPTION OF THE INVENTION

Motorcycles are efficient modes of transportation in many places, however, if the battery should become depleted, or completely discharge, recharging or jumping a motorcycle battery can be challenging due to inaccessibility of the battery terminals. It can he difficult to access the terminals of the ATV, boat, or motorcycle battery in order to attach jumper cables; and if the source-battery for the charge is a car or truck battery, its greater amperage can ruin the battery being recharged unless special care is taken.

The present invention, hereinafter referred to as Bike Jumper Kits, provides a solution to these problems in a simple, easily used system of jumper cables designed specifically for use with motorcycles, ATVs, boats, and similar vehicles. Recognizing the potential to develop a versatile system of jumper cables and connectors for use in charging and jump starting motorcycles. ATVs, boats, and similar vehicles, the present invention was developed The Bike Jumper Kits present the owners of motorcycles and similar vehicles equipped with relatively low-amperage batteries with a system of jumper cables that can be used in conjunction with either a battery tender, or with another low-amperage battery or even a car or truck battery, to jump start the dead cycle or other vehicle. To be manufactured by the Current-Carrying Wiring Devices industry, Standard Industrial Code 3463, the Bike Jumper Kits contain several components, as illustrated in the accompanying drawing figures.

One novel feature of the present invention reside in the manner in which it overcomes the problem of giving access to the terminals of the low-amperage battery to be jumped, and the versatility it offers with regard to Jumping the low amperage battery from either a battery tender or charger or another battery. The first problem, that of access to terminals in the “dead” battery, is solved by the installation of a 12-inch, 10 gauge, paired cable, one end of which terminates in paired metal rings, wherein red is positive and black is negative. These rings are mounted and fastened in place over the battery terminals on the battery of the motorcycle, ATV, boat. This short, twelve inch cable ends in two connectors. Namely, the negative terminal is a male connector and the positive terminal is a female connector. In addition, the cable comprises a 20 amp in-line fuse. The connectors when not in use, are protected with form fitting end-cap protectors, and the cable is stowed in a secure but accessible spot. In the event that the battery, so equipped, requires a jump, the Bike Jumper Kits offer three options: 1) through the use of an interceding, 5-foot, 10-gauge auxiliary cable that connects with the short cable just described, the battery can be recharged through connection to an appropriately graded battery tender or charger; 2) through connection to the short (male-and female-ended) cable previously described, the battery can be recharged by a higher amperage car or truck battery, with a 5-foot, 10-gauge, paired cable that terminates at one end with alligator clamps, and at the other in female and male ended connectors that mate with the short cable(s); and 3) the “dead” battery can be recharged by connection to the battery of another motorcycle. ATV boat, or similar vehicle, again by the use of an intermediary cable with either the corresponding male and female connectors and receivers, or with smaller alligator clamps.

With the system presented in the Bike Jumper Kits, the owner of a motorcycle, ATV, boat, snow machine, personal watercraft, lawn tractor, or similar vehicle will have the means to access and recharge his or her battery quickly, and to do so with whatever is most convenient and close at hand; another similar vehicle, a car or truck, or a battery tender. The Bike Jumper Kits are both instantly adaptable and sufficiently versatile to get the bike, boat, ATV, or other machine back on its way, and because the individual cables and connectors of the Bike Jumper Kits are compact and flexible, the system is easily stowed in the luggage or gear compartment of any motorcycle, ATV, or similar vehicle. For anyone who has attempted to gain access to a motorcycle's battery terminals in a dead-battery situation, and then tried to recharge by fastening a jumper-cable's alligator clamps to the terminals, the convenience and ease of use of the Bike Jumper Kits will be a welcome solution. This well-considered, widely applicable system is not only extraordinarily useful but also eminently affordable, and will therefore find a wide and enthusiastic response in the marketplace.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A kit comprising an improved battery charger system for motorcycles and other smaller battery equipped machines containing cables for jump starting and charging small battery machines such as motorcycles. ATVs, boats and other similar vehicles.

2. The kit of claim 1, comprising a cable designed for battery to bike connection.

3. The kit of claim 1 comprising a cable designed for jumper cable to bike connection.

4. The kit of claim 1 comprising a cable designed for bike to bike connection.

5. The kit of claim 1 comprising a cable designed for battery to bike connection.

6. The kit of claim 1 comprising a 12 inch cable wherein the cable has a first end and a second end, is approximately 12 inches in length, 10 gauge in diameter, and the first end of the cable terminates in a pair of conductive metal rings, wherein one ring is red for positive and the second ring is black for negative and wherein the pair of rings are capable of being mounted and fastened in place over the battery terminals on the battery of the motorcycle, ATV, boat, and the second end of the cable terminates in two connectors wherein the negative terminal is a male connector and the positive terminal is a female connector.

7. The kit of claim 6 further comprising a 20 amp in-line fuse.

8. The kit of claim 1 wherein the connector ends of the cable are protected with form fitting end-cap protectors, and the cable is stowed in a secure but accessible spot.

9. The kit of claim 7 further comprising a five foot, 10 gauge auxiliary cable that connects with the 12 inch cable to enable the battery being recharged through connection to an appropriately graded battery tender or charger.

10. The kit of claim 7 further comprising a five foot, 10 gauge auxiliary cable wherein the five foot, 10-gauge auxiliary cable has a first end and a second end that terminates at its first end with alligator clamps, and at the second end in female and male ended connectors that mate with the 12 inch cable.
